(19) United States
(12) Patent Application Publication
(10) Pub. No.: US 2007/0183507 A1
(43) Pub. Date: Aug. 9, 2007

(54) Decoding scheme for variable block length signals

(75) Inventors: Avneesh Maheshwari, Eindhoven (NL); Wido Kruijtzer, Eindhoven (NL)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: KONINKLIJKE PHILIPS ELECTRONICS N.V., EINDHOVEN NETHERLANDS (NL)

(21) Appl. No.: 10/590,190

(22) PCT Filed: Feb. 2, 2005
(86) PCT No.: PCT/IB05/50437

§ 371 Date: Aug. 17, 2006

(30) Foreign Application Priority Data
Feb. 19, 2004 (EP) 04100664.4

(51) Int. Cl. H04N 7/173

(52) U.S. Cl. 375/240.25; 725/100

(57) ABSTRACT

The present invention relates to a two-step decoding approach, where the size of a media block is first calculated or determined based on a subset of information from a bitstream. This size information defines the number of bytes or length of the media block. The size information is then used to chop-off or extract the first media block from the following second media block and rest of the bit-stream. This step requires less computation or processing than the actual decoding step. Normal decoding of the first media block can then proceed, while the processing elements of the parallel architecture can already jump to the second media block using the size information obtained in the first step, without waiting for the end of processing of the first media block. In this way, decoding times get reduced, as the underlying architecture is able to harness the parallelism by decoding multiple blocks at the same time.

The present invention relates to a decoding method and apparatus for decoding a data stream comprising a plurality of data blocks. In particular, the present invention relates to audio and/or video decoding schemes for media data streams with variable block lengths.

Popularity of digital audio is steadily increasing. More and more people are using compressed digital audio for exchanging music and audio files over the Internet. Digital versatile disc (DVD), music CD's, television and radio broadcasting industry; all have recognized the advantages of delivering good quality compressed audio. DVD and HDTV (High Definition Television) industry has committed to provide their users multi-channel, theatre quality sound experience. The Dolby Digital coding system, also known as Dolby AC-3, which is the audio compression standard for DVDs and HDTV broadcast, significantly reduces the data rate of channel programs, e.g., from 6 Mb/s (6 channel, 20 bits, 48 kHz), down to 384 kb/s, which corresponds to a reduction of 15 to 1.

For such media applications, bit stream formats are composed of frame structures in which a frame is composed of several media blocks. These media blocks in turn contain their own parameters and data. In the architecture world, the trend is to go towards parallel processing architectures. In these architectures, the goal is to separate and take out the media blocks from the bit-stream and feed them in parallel to the processing elements of the architecture. To achieve this, it is required to identify the ends of the media blocks, so that they can be separated from each other. To identify the separation between media blocks, currently two approaches are used:
1. Each media block has an explicit separator field added at the end of each media block. This helps in identifying the end of one media block with the start of another media block.
2. The size of each media block in bytes is forced to be fixed. Since each media block now has a fixed size, it can be jumped over this fixed number of bytes, so as to recognize the start of the next media block.

However, there are standards where these media blocks do not have a fixed size and do not have any separator field. An example of such a standard is the above Dolby

AC-3 standard for DVD's and HDTV broadcast. In standards like this, the above two approaches cannot work.

It is an object of the present invention to provide a decoding method and apparatus, by means of which parallel processing architectures can be implemented for media applications with variable block lengths without requiring separator fields.

This object is achieved by a decoding apparatus as claimed in claim 1 and a method as claimed in claim 10.

Accordingly, decoding requires less computation or processing due to the fact that decoding of the first data block can be proceeded, while the processing elements of the parallel architecture can already jump to the second data block using the block length obtained from the size determination, without waiting for the end of processing of the first data block. In this way, decoding times get reduced, as the underlying architecture is able to exploit or harness parallelism by decoding multiple blocks at the same time.

The size determination means may be adapted to generate a size information and to supply the size information to the separation means. The size information may then be used by the separation means to separate the first data block from the data stream. Thereby, a preemptive block separation can be provided while the size information can be generated from a feedback information obtained from one of the concurrently operating decoding means, to enable a jump by the separating means to the second data block.

The processing of the size determination means may be an accumulation processing for accumulating a determined bit number of predetermined portions of the first data block.

In particular, the plurality of data blocks may be audio blocks of a media application frame, such as an AC-3 frame, and the predetermined portions may be mantissa portions. Thus, the length of the data blocks can be successively obtained during a preliminary parsing or decoding operation the data stream. The determined number of bits may be obtained from a bit allocation processing. This bit allocation processing may be based on at least one psychoacoustic model, wherein power spectral densities are compared with masking curves in order to reveal said bit number.

Furthermore, the parallel processing means may be arranged to parse bit stream information of a first frame of the data stream and then to jump to the start of a subsequent second frame, without waiting for the end of parsing of a side information of audio blocks provided in the first frame. In this way, parsing and decoding of the bit stream information of the second frame can be started before the end of parsing of the audio block, to thereby increase concurrency.

Additionally, the separation means may be arranged to unpack the side information of a first audio block, then parse and send an exponent information to a first processing unit of the parallel processing means, a bit allocation information to a second processing unit of the parallel processing means, and a mantissa block to a third processing unit of the parallel processing means, and then jump to a second audio block. Hence, information is just parsed and sent to the respective processes without waiting for the processes to get finished before jumping to the next audio block of the block sequence.

Further advantageous modifications are defined in the dependent claims.

The present invention will now be described on the basis of a preferred embodiment with reference to the accompanying drawings, in which:

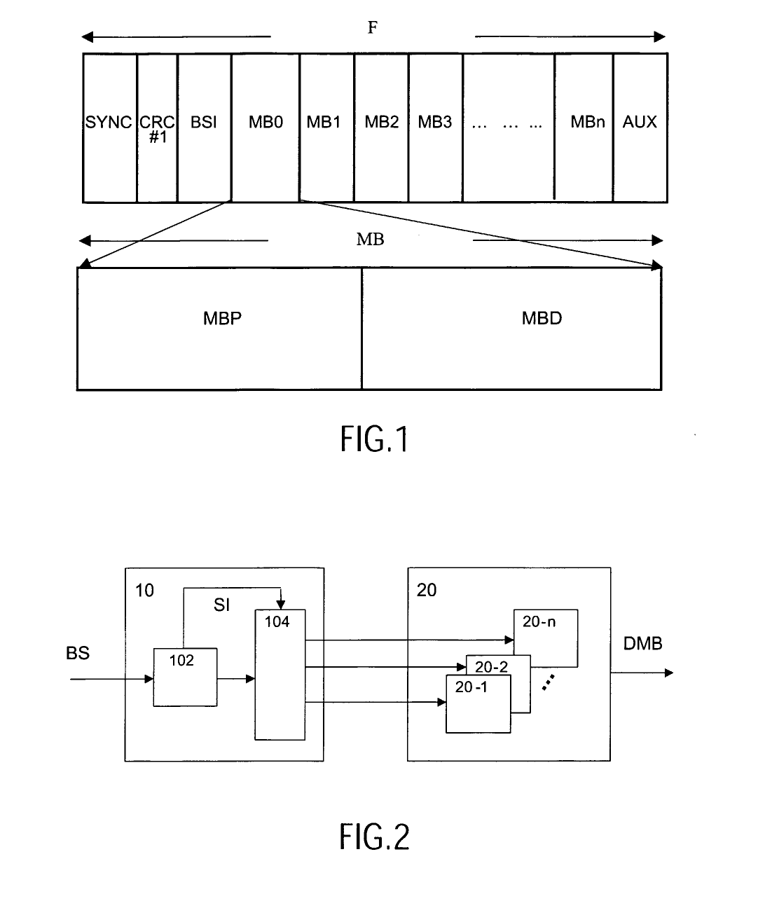

FIG. 1 shows a typical bit stream structure of a frame of a media application to which the present invention can be applied,

FIG. 2 shows a schematic block diagram of a two-step decoding scheme according to the present invention;

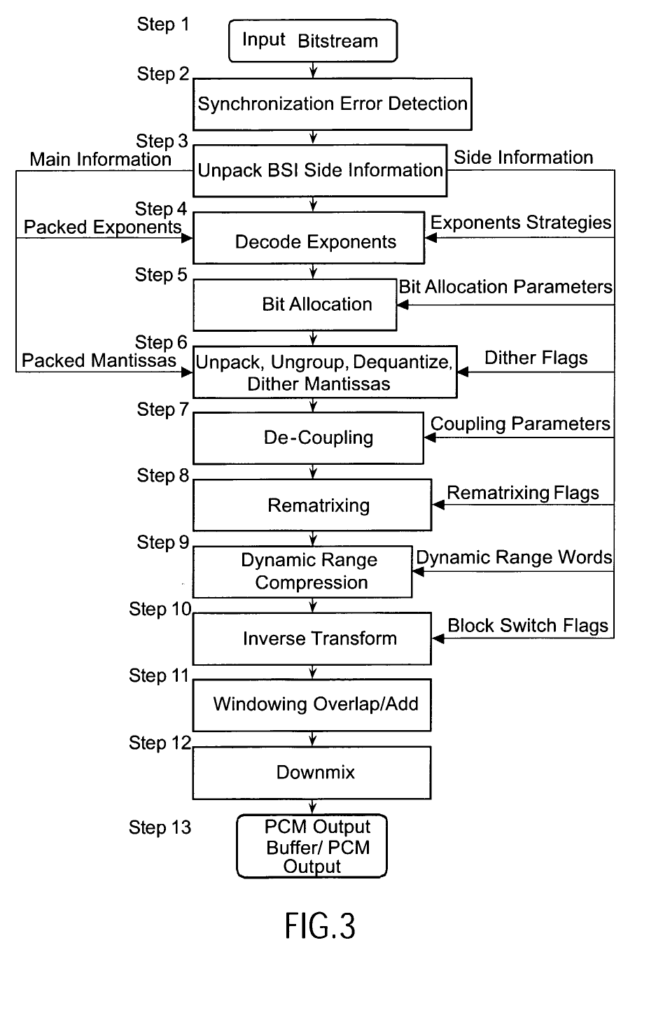

FIG. 3 shows a schematic flow diagram of a typical Dolby Digital decoding scheme; and

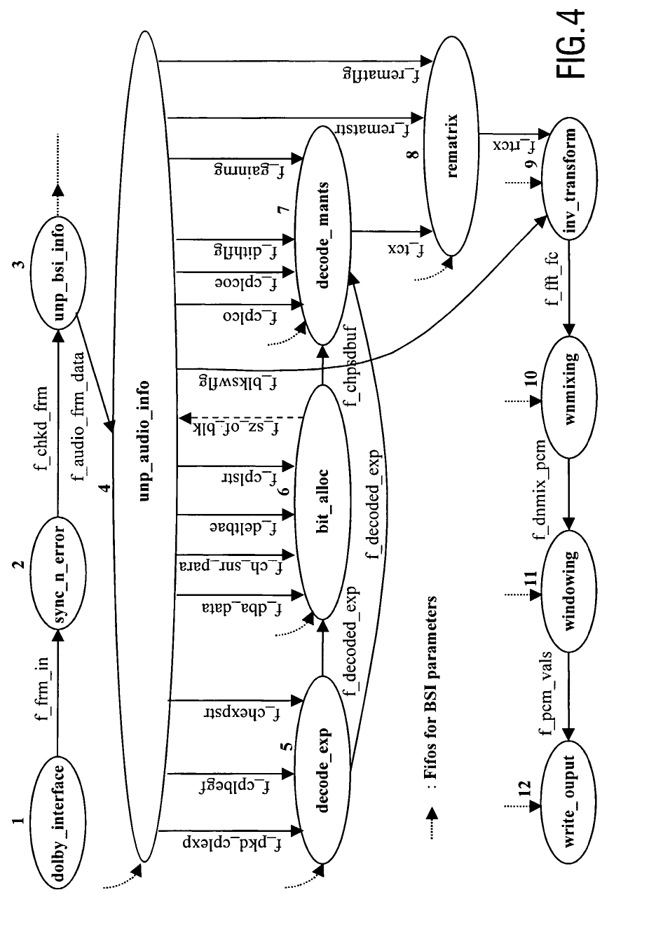

FIG. 4 shows a schematic functional diagram of a Dolby Digital decoding process according to the preferred embodiment.

The preferred embodiment will now be described on the basis of a Dolby Digital decoder, i.e. Dolby AC-3 audio decoder.

In the past several years, digital audio data compression has become an important technique in the audio industry. Dolby AC-3 is a flexible audio data compression technology capable of encoding a range of audio channel formats into a low rate bit stream. The genesis of the AC-3 technology came from a desire to provide superior multi-channel sound localization for High Definition Television (HDTV). The goal was to have coded audio, which is usable by as wide an audience as possible. The potential audience may range from patrons of a commercial cinema or home theatre enthusiasts who wish to enjoy the full sound experience, to the occupant of a quiet hotel room listening to a mono TV set at low volume who nevertheless wishes to hear all of the program content.

The Dolby AC-3 standard accepts PCM (Pulse Code Modulation) audio as its input and produces an encoded bit stream. The first step in the encoding process is to transform the representation of audio from a sequence of PCM time samples into a sequence of blocks of frequency coefficients. Overlapping blocks of 512 time samples are multiplied by a time window and transformed into the frequency domain. Due to the overlapping blocks, each PCM input sample is represented in two sequential transformed blocks. The frequency domain representation may then be decimated by a factor of two so that each block contains 256 frequency coefficients. In the event of transient signals, improved performance is achieved by using a block-switching technique, in which two 256-point transforms are computed in place of the 512-point transform. A floating-point conversion process breaks the transform coefficients into exponent/mantissa pairs. The mantissas are then quantized with a variable number of bits, based on a parametric bit allocation model. The spectral envelop (exponents) and the coarsely quantized mantissas for 6 audio blocks (1536 audio samples) are formatted into an AC-3 frame.

FIG. 1 shows a schematic structure of a typical frame F of a media application, such as AC-3. The bit stream is a sequence of such frames. As shown in this frame structure diagram, each of the frames consists of a plurality of media blocks MBO-MBn, e.g., audio blocks in the case of an AC-3 frame. Each media block in turn consists of media block parameters MBP and media block data MBD. Furthermore, each frame F may comprise a synchronization word or pattern SYNC, an error correction code (cyclic redundancy code) CRC#1, a bit stream information BSI, and an auxiliary information AUX.

In the specific case of the AC-3 frame, the media block data MBD comprises packed exponents and a mantissa block. To improve parallelism in the decoding process it is desirable to provide a parsing or decoding routine adapted to skip the mantissa block, whose decoding is computation heavy, and to start parsing or decoding the next audio block. To do this, the decoding process or scheme should be capable to identify a “separation point” between the audio or media blocks. As already mentioned, this is usually achieved in conventional media standards by inserting a uniquely identifiable “separator field” between such media blocks or by having fixed-size media blocks. However none of the above solutions are applicable to specific variable size media applications without separation information, such as the AC-3 bit stream.

According to the preferred embodiment, the following two-step or two-stage decoding approach is proposed.

FIG. 2 shows a schematic block diagram indicating the decoding process or scheme according to the preferred embodiment. In the first step or stage 10, the size of a media block, e.g. mantissa block, is calculated or determined by a size determination function or unit 102 from an input bit stream BS comprising e.g. PCM data. A corresponding size information SI is generated and forwarded to a separation function or unit 104. In the separation unit 104, the size information SI is then used to cut the media blocks from the rest of the bit stream and to supply the separated media blocks to selected ones of a plurality of decoding processing functions or units 20-1 to 20-n of a second stage 20. Then, at least partial parallel decoding of the extracted media blocks is performed in the selected decoding processing units 20-1 to 20-n. The decoded media bocks DMB are then combined to a single data stream or directly supplied in parallel to the output of the second stage 20.

In the following, a more detailed description of the preferred embodiment is given based on an AC-3 decoding process.

FIG. 3 shows a schematic flow diagram of a typical AC-3 decoding procedure. In step 1, a bit stream is typically input from a transmission or storage system. The next step 2 is provided to establish frame alignment. This involves finding the AC-3 synchronization word SYNC, and then confirming that the CRC error detection words indicate no errors.

In step 3, side information such as sampling rate, frame sizes, bit rate, number of channels, information related to audio like language codes, copyrights etc., is unpacked, wherein the bit stream information BSI appears once every frame and side information of audio blocks appears once per audio block, e.g., 6 times per frame. Then, in step 4, exponents are delivered in the bit stream in encoded form. Using the side information from the bit stream, exponents are decoded and sent to a bit allocation routine executed in step 5. The bit allocation step comprises computations based on psychoacoustic models, where power spectral densities of the audio are compared with masking curves. These computations reveal how many bit are allocated to each mantissa.

As explained later in connection with the preferred embodiment, the obtained bit allocation number can be used to determine or calculate the size of the mantissa blocks.

Coarsely quantized mantissas make up the bulk of the AC-3 data stream. The mantissa data is unpacked in step 6 by peeling off or extracting groups of bits as indicated by the bit allocation routine. Grouped mantissas are then ungrouped. The individual coded mantissa values are converted into a de-quantized value. When coupling is in use, high frequency components of the coupled channels are reconstructed in step 7 using common coupling channel and coupling coordinates for individual channels. For each audio block a dynamic range is prescribed by the encoder and based on this value, the decoder alters the magnitude of exponents and mantissas using this dynamic range word.

In the two-channel mode, if the encoder employs rematrixing as indicated by step 8, then sum and different values are used in step 8 to extract left and right channels. After dynamic range compression in step 9, frequency domain coefficients are ready to be converted back to time domain using an inverse transformation in step 10. The individual blocks of time samples are windowed in step 11, and adjacent blocks are overlapped and added together to reconstruct the final continuous time domain PCM audio signal.

However, the number of channels in the stream might not match with the number of speakers at user premises. In such a case, downmixing as indicated in step 12 is required to mix the channels in the stream such that they can be reproduced on the number of speakers at the user's premises.

Finally, in step 13, the PCM output is typically written to buffers at the sampling rate or in a form suitable for interconnection to digital to analog converters (DAC), or in any other form.

It is noted that the sequence of steps shown in FIG. 3 is just one of a plurality of possible ways of decoding an AC-3 audio stream. For example, the downmixing in step 12 can be done either in time domain or in frequency domain, as it is a linear operation.

Furthermore, it is to be understood that the flow diagram of FIG. 3 has hidden loops inside it. Steps 1, 2, 11, 12 and 13 work on frame basis, while steps 3-10 iterate on audio block basis. Hence, a typical decoding sequence for a frame F would mean executing steps 1 and 2 once per frame F then repeating steps 3-10 for the number of media blocks MB, e.g. 6 audio blocks for the AC-3 frame, of a frame and then executing steps 11-13 on a frame basis. It also means that steps 3-10 are to be executed serially. In other words, while processing step 6 on the first audio block, step 3 cannot be started on the subsequent second audio block.

In the preferred embodiment a solution is presented to enable independent and thus concurrent execution of the processes corresponding to steps 1-13 in a process network.

FIG. 4 shows a functional process model of an AC-3 decoder scheme according to the preferred embodiment. The model is based on a collection of processes connected to each other via first-in-first-out memories (fifos), shift register memories or the like. Processes and fifos are connected via ports of the processes.

In the functional diagram of FIG. 4, a technique is presented to extract parallelism from the inherently sequential AC-3 decoding algorithm shown in FIG. 3. In the functional diagram of FIG. 4, processes are shown as elliptic circles and fifos are shown as arrows. It is to be noted here that FIG. 4 does not show all the details of the process. For example, it does not show ports and fork processes. As already mentioned, ports are used to connect processes to fifos. Fork processes are required to duplicate tokens. This can happen when for a token, there is one producer and multiple consumers. All that a fork process does is read a token from its input fifo and write copies of it on multiple output fifos. While communicating tokens between processes via fifos, tokens represent values instead of references to the values. This means if two processes have to share data, they share the data explicitly by writing and reading the data from the fifo, and not by writing and reading pointers to the data.

Also not shown in FIG. 4 is the complete list of arrows that represents the fifos between processes. Depicting all fifo arrows in FIG. 4 is not feasible for the sake of readability of the diagram.

In FIG. 4, the processes 1, 2 and 8 respectively correspond to the steps 1, 2 and 8 of FIG. 3, while the processes 5, 6, and 9 to 12 correspond to the steps 4, 5 and 10 to 13 of FIG. 3. The “Unpack BSI, Side Info” step (step 3) of FIG. 3 has been split into two processes 3 and 4, namely, “unp_bsi_info” (process 3) and “unp_audio_info” (process 4). Furthermore, steps 6, 7 and 9 of FIG. 3, namely “Unpack, Ungroup, Dequantize, Dither Mantissa”, “De-Coupling” and “Dynamic Range Compression”, have been merged into a single process 7, namely the process “decode_mants”. The reasons for these are explained in the following.

Instead of two processes 3 and 4 of FIG. 4 there was a single step 3 in FIG. 3 that covered the functionality of “Unpack BSI, Side Information Process”. In the conventional scheme of FIG. 3, an AC-3 frame is parsed in the following way. First, the bit stream information (BSI) is decoded or parsed, which appears once per frame in the header of the frame. Then, the side information of the first audio block is parsed or decoded. To start parsing the BSI of the next frame; step 3 would first have to finish parsing or decoding the side information of all audio blocks. To increase concurrency, it is therefore proposed to parse or decode the BSI of the first frame and then jump to the start of the next frame. In this way, parsing or decoding of the BSI of second frame can be started without waiting for the end of parsing of the audio blocks of first frame.

According to the preferred embodiment of FIG. 4, step 3 of FIG. 3 is divided into the two processes 3 and 4, wherein the BSI information of the frames is unpacked in process 3 and the audio side information of the audio blocks is unpacked in process 4. Process 3 thus works on a frame basis and parses or decodes only the BSI information of every frame, while the rest of the frame is passed to process 4 which works on audio block basis and parses the side information contained in each audio block.

According to the AC-3 frame structure, each of the AC-3 frames consists of six audio blocks. Each audio block in turn consists of parameters, packed exponents and a mantissa block. Hence, as already mentioned, it is desired to skip the mantissa block and start parsing the next audio block. To do this, a “separation point” must be identified between the mantissa blocks. To solve this problem, the two-step decoding approach of FIG. 2 is used. In other words, process 4 of FIG. 4 (unpack audio side information) first unpacks the side information of the first audio block, then parses and sends encoded exponents to process 5 (decode exponents), parses and sends bit allocation data to process 6 (bit allocation), parses and sends compressed mantissa block to process 7 (decode mantissa), and then repeats this procedure again for the second audio block. The point is that it just parses and sends information to the corresponding processes and then without waiting for the processing of the first audio block to get finished by the other processes 5 to 7, it jumps to the subsequent second audio block.

The above concurrent procedure requires that the size of the compressed mantissa block is known. To overcome this algorithmic obstacle, it is proposed to manipulate process 6. Using psychoacoustics models, process 6 determines how many bits should be stripped from the mantissa block, for the first mantissa. It stores this information in a variable called bit allocation pointer (BAP). The BAP is then used by process 7 to strip bits from the compressed mantissa block for the first mantissa. This mantissa is decoded and stored in an array for further processing. Next, the BAP for the second mantissa is calculated to be used by process 7 to strip bits from the compressed mantissa block of the bit stream. This process of finding or obtaining the BAP and then using it to strip bits from the bit stream is repeated for all mantissas of all channels that are present in the first audio block. When all mantissas of the first audio block have been stripped from bit stream, the parsing or decoding of the second audio block or next audio block in sequence can proceed.

However, if all the BAPs of the first audio block were summed up, then this sum would represent the size of compressed mantissa block of the first audio block. So the trick is to send this determined or calculated sum of BAPs to process 4 via the fifo “f_size_of_blk” (dashed arrow in FIG. 4), so that process 4 can then “chop” a number of bits corresponding to the sum of BAPs from the bit stream and send this compressed mantissa block to process 7. In this way, process 4 can start parsing the second audio block without waiting for the end of processing of the first audio block.

In the above approach, every process waits only for the necessary and sufficient information that it needs to complete its computation. By the way, this is also a very good example of how algorithmic manipulations, at an abstractions level like YAPI, can save enormous number of cycles. Referring back to FIG. 2, it can thus be followed that the first stage 10 of FIG. 2 corresponds to process 4 of FIG. 4, while the second stage 20 of FIG. 2 basically corresponds to processes 5 to 7.

In summary, a two-step decoding approach is proposed, where the size of a media block is first calculated or determined based on a subset of the information from the bit-stream. This size information defines the number of bytes or length of the media block. The size information is then used to chop-off or extract the first media block from the following second media block and rest of the bit-stream. This step requires less computation or processing than the actual decoding step. Normal decoding of the first media block can then proceed, while the processing elements of the parallel architecture can already jump to the second media block using the size information obtained in the first step, without waiting for the end of processing of the first media block. In this way, decoding times get reduced, as the underlying architecture is able to harness the parallelism by decoding multiple blocks at the same time.

It is noted that the present invention is not intended to be restricted to the above preferred AC-3 embodiment but can be implemented in any decoding apparatus or method, where variable length blocks are processed. In particular, any suitable subset of the bit-stream information may be used to calculate or derive the size of any kind of block, so as to enable at least partially concurrent or parallel processing of information provided in subsequent blocks. The preferred embodiments may thus vary within the scope of the attached claims.

1. A decoding apparatus for decoding a data stream comprising a plurality of data blocks, said apparatus comprising:
a. size determination means (102) for processing a subset of the information of said data stream in order to determine the length of a first data block to be decoded;
b. separation means (104) for separating said first data block from said data stream based on said determined length; and
c. parallel processing means (20) for decoding a subsequent second data block while said first data block is decoded.

2. Apparatus according to claim 1, wherein said size determination means (102) is adapted to generate a size information and to supply said size information (f_sz_of_blk) to said separation means (104).

3. Apparatus according claim 2, wherein said size information is used by said separation means (104) to separate said first data block from said data stream.

4. Apparatus according to any one of the preceding claims, wherein said processing of said size determination means (102) is an accumulation processing for accumulating a determined bit number of predetermined portions of said first data block.

5. Apparatus according to claim 4, wherein said plurality of data blocks are audio blocks of a media application frame, and said predetermined portions are mantissa portions.

6. Apparatus according to claim 4 or 5, wherein said determined number of bits is obtained from a bit allocation processing.

7. Apparatus according to any one of claims 4 to 6, wherein said bit allocation processing is based on at least one psychoacoustic model, wherein power spectral densities are compared with masking curves in order to reveal said bit number.

8. Apparatus according to any one of claims 5 to 7, wherein said parallel processing means (20) are arranged to parse bit stream information of a first frame of said data stream and then to jump to the start of a subsequent second frame, without waiting for the end of parsing of a side information of audio blocks provided in said first frame.

9. Apparatus according to claim 8, wherein said separation means (104) are arranged to unpack said side information of a first audio block, then parse and send an exponent information to a first processing unit of said parallel processing means (20), a bit allocation information to a second processing unit of said parallel processing means (20), and a mantissa block to a third processing unit of said parallel processing means (20), and then jump to a second audio block.

10. A method of decoding a data stream comprising a plurality of data blocks, said method comprising the steps of:
processing a subset of the information of said data stream in order to determine the length of a first data block to be decoded;
separating said first data block from said data stream based on said determined length; and
decoding a subsequent second data block while said first data block is decoded.
